(19) United States
(12) Patent Application Publication
(10) Pub. No.: US 2017/0316384 A1
(43) Pub. Date: Nov. 2, 2017

(54) METHODS AND SYSTEMS FOR SCHEDULING AND MANAGING MANICURE/PEDICURE APPOINTMENTS AND PAYMENTS

(71) Applicant: Matt Person, Miami, FL (US)

(72) Inventor: Matt Person, Miami, FL (US)

(21) Appl. No.: 15/141,094

(22) Filed: Apr. 28, 2016

(51) Int. Cl. G06Q 10/10; G06Q 20/10

(52) U.S. Cl. CPC G06Q 10/1095; G06Q 20/102

(57) ABSTRACT

A method and system for scheduling and managing manicure and/or pedicure appointments and payments includes: initiating a predefined electronic payment from individual consumers at predefined intervals of time, receiving appointment requests from individual consumers, routing each appointment request a manicure and/or pedicure provider, receiving messages indicating that a consumer has consumed an offered service at a manicure and/or pedicure provider, generating a human-readable spreadsheet file that lists a unique provider and a predefined payment amount, calculating a monetary transfer amount for each manicure and/or pedicure provider, and generating a NACHA-formatted file based on said spreadsheet file, wherein said NACHA-formatted file lists a unique provider, the monetary transfer amount, the provider bank account data and source bank account data.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The claimed subject matter relates to the field of electronic commerce, and more specifically, the claimed subject matter relates to the field of scheduling appointments and making payments in electronic commerce.

### BACKGROUND

Consumers are increasingly concerned about grooming, health and beauty. Due to the increasing cost of said services, however, consumers can unwittingly end up spending hundreds, if not thousands, of dollars every month on haircuts, manicures, pedicures and massages. Others may spend more money than they should on grooming, health and beauty related services by using credit. Yet others simply cannot afford the increasing cost of grooming, health and beauty related services, especially those offered from high-end boutiques. In some cases, consumers may simply be unaware of certain grooming, health and beauty providers that are affordable.

While the Internet has provided a means for consumers to search for various types of grooming, health and beauty related providers that may provide excellent quality services, it may be difficult to find certain providers on the Internet given the increasing amount of paid-for Internet advertising. This leads to under-used grooming, health and beauty service providers. Further, many grooming, health and beauty providers often have appointment time slots that remain un-booked and un-used, which is inefficient and causes loss of revenue. In other cases, certain high-end grooming, health and beauty related providers, are willing to fill certain appointment time slots at a lower cost to the individual consumer, in order to recoup some lost revenue due to the un-booked appointment time slot. But often, said service providers simply cannot find consumers to fill said un-used time slots, even at a lower price.

Currently, there is no efficient way for consumers to find different types of grooming, health and beauty providers to which they would not naturally be exposed, or which are difficult to find on the Internet. Additionally, there is currently no economic way for health and beauty service providers to fill un-used appointment time slots with consumers that would not normally frequent said providers for a variety of reasons, including the undiscounted cost of said services. Further, there is currently no efficient way for grooming, health and beauty providers to be exposed to consumers to which the providers would not normally cater.

Therefore, what is needed is a system and method for improving the problems with the prior art, and more particularly for a more efficient method and system for facilitating the scheduling of appointments for grooming, health and beauty service providers and for managing payments for same.

### SUMMARY

Methods and systems for scheduling and managing manicure and/or pedicure appointments and payments are disclosed. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, a method and system for scheduling and managing manicure and/or pedicure appointments and payments comprises: receiving, via a communications network communicably coupled with the server, consumer data from a plurality of individual consumers, wherein said consumer data includes electronic payment information, generating and storing a plurality of consumer records corresponding to said plurality of individual consumers, wherein each consumer record includes said consumer data and a unique consumer identifier for an individual consumer, generating and storing a plurality of provider records corresponding to a plurality of manicure and/or pedicure providers that provide offered services, wherein each provider record includes provider data, provider bank account data and a unique provider identifier for a manicure and/or pedicure provider, initiating a predefined electronic payment from said plurality of individual consumers at predefined intervals of time, using said electronic payment information stored in the plurality of consumer records, receiving a plurality of appointment requests from said plurality of individual consumers, wherein each appointment request includes a unique consumer identifier, a unique provider identifier and a date and time for an appointment, routing each appointment request of the plurality of appointment requests to a manicure and/or pedicure provider identified in each appointment request by said unique provider identifier, receiving a plurality of messages from said plurality of manicure and/or pedicure providers, wherein each message indicates that a consumer has consumed an offered service at a manicure and/or pedicure provider, and wherein each message includes a unique consumer identifier and a unique provider identifier, generating a human-readable spreadsheet file based on said plurality of messages, wherein said spreadsheet file lists, for each offered service that was consumed, the unique provider identifier corresponding to said offered service, and a predefined payment amount corresponding to said offered service, calculating, for each manicure and/or pedicure provider of said plurality of manicure and/or pedicure providers, a monetary transfer amount by multiplying a number of instances of consumers consuming an offered service at said manicure and/or pedicure provider by the predefined payment amount corresponding to said offered service, and, generating a NACHA-formatted file based on said spreadsheet file, wherein said NACHA-formatted file lists, for each manicure and/or pedicure provider of said plurality of manicure and/or pedicure providers, the unique provider identifier, the monetary transfer amount, the provider bank account data corresponding to the unique provider identifier and source bank account data.

Additional aspects of the disclosed embodiment will be set forth in part in the description which follows, and in part will be obvious from the description, or may be learned by practice of the disclosed embodiments. The aspects of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute part of this specification, illustrate embodiments of the claimed subject matter and together with the description, serve to explain the principles of the disclosed embodiments. The embodiments illustrated herein are presently preferred, it being understood, however, that the claimed subject matter is not limited to the precise arrangements and instrumentalities shown, wherein:

FIG. 1 is a block diagram illustrating the network architecture of a system for scheduling and managing manicure and/or pedicure appointments and payments, in accordance with one embodiment.

FIG. 2 is a block diagram showing the general data flow for the method for scheduling and managing manicure and/or pedicure appointments and payments over a communications network, according to one embodiment.

FIG. 3 is a block diagram showing the data flow of the process for editing human-readable spreadsheet files over a communications network, according to one embodiment.

FIG. 4 is a block diagram showing the data flow of the process for generating and transmitting NACHA formatted files and executing ACH transfers over a communications network, according to one embodiment.

FIG. 5A is a flow chart depicting the general control flow of the process for enrolling consumers and effectuating payment from same over a communications network, according to one embodiment.

FIG. 5B is a flow chart depicting the general control flow of the process for enrolling manicure and/or pedicure providers over a communications network, according to one embodiment.

FIG. 6A is a flow chart depicting the general control flow of the process for booking appointments for offered services, according to one embodiment.

FIG. 6B is a flow chart depicting the general control flow of the process for reporting on consumer activity, according to one embodiment.

FIG. 6C is a flow chart depicting the general control flow of the process for making monetary transfers to manicure and/or pedicure providers, according to one embodiment.

FIG. 7 is a block diagram of a system including an example computing device and other computing devices.

### DETAILED DESCRIPTION

The following detailed description refers to the accompanying drawings. Whenever possible, the same reference numbers are used in the drawings and the following description to refer to the same or similar elements. While disclosed embodiments may be described, modifications, adaptations, and other implementations are possible. For example, substitutions, additions or modifications may be made to the elements illustrated in the drawings, and the methods described herein may be modified by substituting reordering, or adding additional stages or components to the disclosed methods and devices. Accordingly, the following detailed description does not limit the disclosed embodiments. Instead, the proper scope of the disclosed embodiments is defined by the appended claims.

The disclosed embodiments improve upon the problems with the prior art by allowing individual consumers to more efficiently schedule appointments with manicure and/or pedicure providers to which the individual consumers would not normally have access. The disclosed embodiments also improve over the prior art by providing the ability for consumers to view available appointment slots for numerous manicure and/or pedicure providers at one time. Further, the disclosed embodiments provide the ability for manicure and/or pedicure providers to have unfilled appointment slots advertised to consumers that can efficiently schedule an appointment for his or herself. Additional improvements include providing an efficient means for consumers to pay for manicure and/or pedicure services, and an efficient means for manicure and/or pedicure providers to receive payments for services rendered, “no-show” appointments, as well as cancelled appointments. Also, system administrators may pay numerous manicure and/or pedicure providers at one time by using automatically generated human readable spreadsheet files and a NACHA file. These improvements over the prior art, and others, will more clearly be explained below.

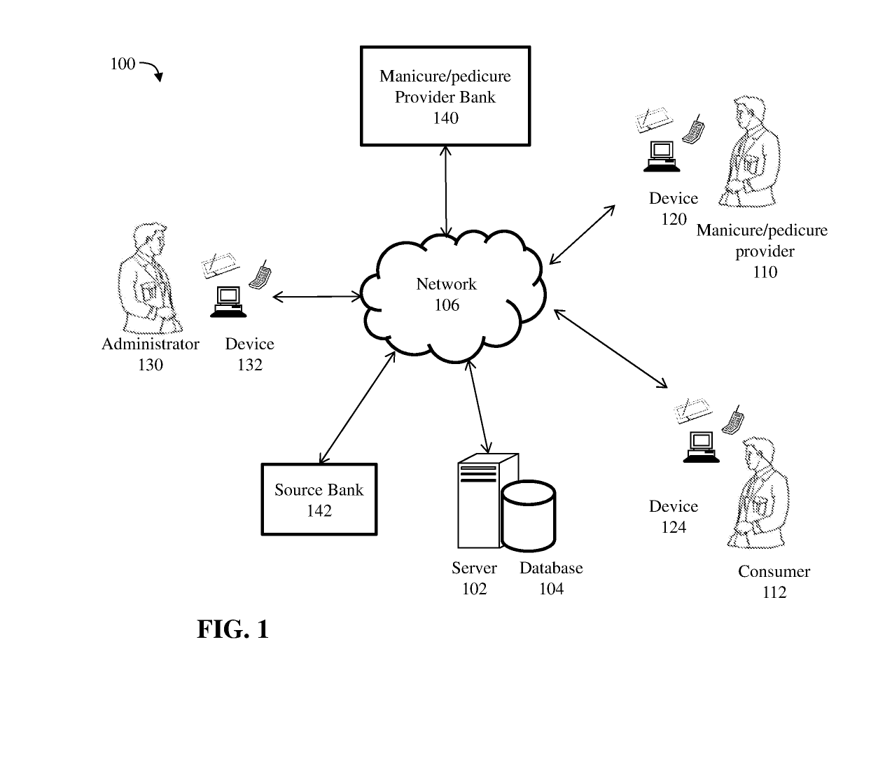

Referring now to the Figures, in this document the terms “provider” and “manicure and/or pedicure provider” may be used interchangeably, and the terms “individual consumer” and “consumer” may be used interchangeably. Referring now to the drawing figures in which like reference designators refer to like elements, there is shown in FIG. 1 an illustration of a block diagram showing the network architecture of a system 100 for scheduling and managing manicure and/or pedicure appointments and payments in accordance with the principles of the claimed subject matter. A prominent element of FIG. 1 is the server 102 associated with repository or database 104 and further coupled with network 106, which can be a circuit switched network, such as the Public Service Telephone Network (PSTN), or a packet switched network, such as the Internet or the World Wide Web, the global telephone network, a cellular network, a mobile communications network, or any combination of the above. Server 102 is a central controller or operator for functionality that executes on computing devices 120, 124 and 132, namely, the processes of scheduling and managing manicure and/or pedicure appointments and payments, all of which are provided to the manicure and/or pedicure provider 110 and consumer 112.

FIG. 1 further includes computing devices 120, 124, 132, which may be smart phones, mobile phones, tablet computers, handheld computers, laptops, wearable computers, wristwatch computers, desktop computers or the like. Computing device 120, corresponds to a manicure and/or pedicure provider 110. Computing devices 124 correspond to an individual consumer 112. Computing device 132 corresponds to a system administrator 130. The manicure and/or pedicure provider 110 can include a manicure and/or pedicure provider that provides offered services such as manicures, pedicures, massages, facials or other services offered by grooming, health and beauty professionals, etc., that are intended to be consumed by consumer 112. The consumer 112 is an individual that desires to consume offered services offered by the manicure and/or pedicure provider 110. The system administrator 130 is an administrator that may have the ability to review and edit any of the recorded transactions and may perform supervisory or administrative tasks on the server 102 evidencing the interactions between the plurality of individual consumers and the plurality of manicure and/or pedicure providers.

FIG. 1 further shows that server 102 includes a database or repository 104, which may be a relational database comprising a Structured Query Language (SQL) database stored in a SQL server. Devices 120, 124 and 132 may also each include their own database. The repository 104 serves data from a database, which is a repository for data used by server 102 and devices 120, 124 132 during the course of operation of the claimed subject matter. Database 104 may be distributed over one or more nodes or locations that are connected via network 106.

The database 104 may include a consumer record for each individual consumer 112. A consumer record may include: contact/identifying information for the individual consumer (name, address, telephone number(s), email address, etc.), electronic payment information for the user, such as bank account information, debit or credit card account information, password data, a unique consumer identifier for each consumer, a residential address for each user, the current location of each consumer (based on location-based services from the consumer's mobile computer) and a description of past services/products purchased by each consumer. A consumer record may further include demographic data for each consumer, such as age, sex, income data, race, color, marital status, etc.

In one embodiment, database 104 holds at least 100,000 consumer records. This number of records is significant in the industry because it represents a minimum number of consumers that must participate in the system in order to have an efficient system that is worthwhile, financially, for the providers. I.e., said number of consumers are necessary in order to provide an acceptable return on investment for participating providers. If the number of consumers participating in the disclosed system were less than said number, then the system may not be worthwhile, financially, for the providers.

The database 104 may include a provider record for each of a plurality of manicure and/or pedicure providers 110. A provider record may include: contact/identifying information for each individual manicure and/or pedicure provider (name, address, telephone number(s), email address, etc., business license information), provider bank account information for the provider, such as a bank account number, routing number, bank name, swift code number, etc., a unique provider identifier for each provider, a provider address for each provider, a description of offered products and/or services provided or offered by each manicure and/or pedicure, a price list for the products/services offered, a price list for cancellations, a price list for “no-shows”, the start time and end time and date of available appointments, the start time and end time and date of blackout periods, and an identifier for each offered product/service.

In one embodiment, database 104 holds at least 10,000 provider records. This number of records is significant in the industry because it represents a minimum number of providers that must participate in the system in order to have an efficient system that is worthwhile for the consumers. I.e., said number of providers are necessary in order to provide a system that has enough availability of offered services to promptly supply the demand for manicure and/or pedicure services by participating consumers. If the number of providers participating in the disclosed system were less than said number, then the system may not be worthwhile for the consumers.

The database 104 may also include human-readable and human-editable spreadsheet files. Each human-readable spreadsheet file may list in each row: an offered service that was consumed, a unique provider identifier at which the offered service was consumed, a predefined payment amount corresponding to said offered service that was consumed, the unique consumer identifier that consumed said offered service, etc. Further, each human-readable spreadsheet file may list in each row: a payment identifier, a unique provider identifier, a predefined payment amount corresponding to said payment identifier, a unique consumer identifier, etc. Also, each human-readable spreadsheet file may list in each row: a date and time, a time period identifier, a start time and date and an end time and date for the time period, etc.

The database 104 may also include NACHA formatted files. The NACHA (previously the National Automated Clearing House Association) manages the development, administration, and governance of the ACH Network, the backbone for the electronic movement of money and data in the United States. The ACH Network serves as a network for direct consumer, business, and government payments, and annually facilitates billions of payments such as direct deposit and direct payment. An ACH transfer refers to a monetary transfer that uses the ACH Network. A NACHA formatted file is a file that is formatted according to NACHA standards. A NACHA formatted file is used to define a plurality of ACH transfers.

A NACHA formatted file may list in each row: an offered service that was consumed, a unique provider identifier at which the offered service was consumed, a predefined payment amount corresponding to said offered service that was consumed, the unique consumer identifier that consumed said offered service, the provider bank account data corresponding to the unique provider identifier, source bank account data, etc. Further, a NACHA formatted file may list in each row: a payment identifier, a unique provider identifier, a predefined payment amount corresponding to said payment identifier, a unique consumer identifier, the provider bank account data corresponding to the unique provider identifier, source bank account data, etc. Also, a NACHA formatted file may list in each row: a monetary transfer amount, a unique provider identifier, a unique consumer identifier, the provider bank account data corresponding to the unique provider identifier, source bank account data, etc. Also, each row may include: a date and time, a time period identifier, a start time and date and an end time and date for the time period, etc.

FIG. 1 shows an embodiment wherein networked computing devices 120, 124 and 132 interact with server 102 and repository 104 (as well as banks 140, 142) over the network 106. Server 102 includes a software engine that delivers applications, data, program code and other information to networked computing devices 120, 124 and 132 (as well as banks 140, 142). It should be noted that although FIG. 1 shows only four networked computers 120, 124 and 132 (as well as two banks 140, 142) the system supports any number of networked computing devices and banks connected via network 106.

Computing devices 102, 120, 124 and 132 (as well as banks 140, 142) include program logic comprising computer source code, scripting language code or interpreted language code that may be compiled to produce an executable file or computer instructions, or that may be interpreted at run-time, wherein the computer source code performs various functions of the claimed subject matter.

Note that although server 102 is shown as a single and independent entity, in one embodiment, the functions of server 102 may be integrated with another entity, such as one of the 120, 124 and 132 (as well as banks 140, 142). Further, server 102 and its functionality, according to a preferred embodiment, can be realized in a centralized fashion in one computer system or in a distributed fashion wherein different elements are spread across several interconnected computer systems.

The server is configured for automatically generating a human-readable spreadsheet file. Each human-readable spreadsheet file may be editable by the system administrator using a graphical user interface provided by the server to remote computing device 132. The server is also configured for automatically generating a NACHA file based on the spreadsheet file. The computing device 132 of the administrator, or server 102, may transmit, via the communications network, the NACHA file to source bank 142 for generating a plurality of ACH transfers to be transmitted from the source bank to a plurality of provider banks at one time.

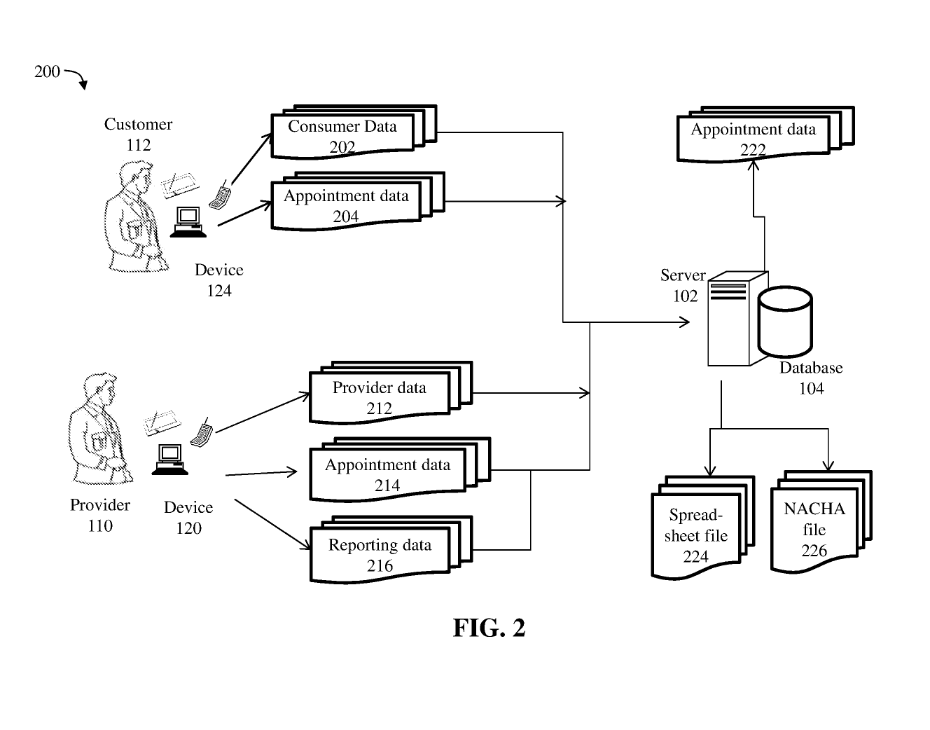

FIG. 2 is a block diagram 200 showing the general data flow for the method for scheduling and managing manicure and/or pedicure appointments and payments over a communications network, according to one embodiment.

FIG. 2 illustrates that the consumer may input consumer data 202, including electronic payment data, using a graphical user interface (GUI) on either computing device 124, wherein the GUI is provided by the server, over the communications network. The server 102 is also configured for receiving, via the communications network communicatively coupled with the server, appointment data 204 to request, cancel, or modify an appointment time from the plurality of individual consumers.

The server is also configured for generating and storing a plurality of consumer records corresponding to said plurality of individual consumers. Each consumer record includes the consumer data 202 (which includes any data that may be found in a consumer record) and a unique consumer identifier for an individual consumer. The consumer may also use an image capturing device on the computing device 124 to capture images of consumer's nails, hands, skin, etc. The user interface provided by the server may allow for the consumer to change color scheme of potential nails for manicure and pedicure to see the selected color on their actual hand on the display screen of the computing device. The user interface provided may also have a timer counting down to their next appointment time on their login screen.

The block diagram illustrates that the server can provide, over the communications network, a GUI on computing device 120, to each manicure/pedicure provider 110. The GUI is configured for allowing each manicure/pedicure provider to input provider data 212, which includes any data that may be found in a provider record. The GUI may also be used to input information regarding the offered services, such as the type of service, special requirements, legal disclaimers, etc. The server 102 is also configured for receiving from provider 110, via the communications network communicatively coupled with the server, appointment data 214, which may include the date, start time, duration and end time of each available appointment. Appointment data 214 may also include blocked out period of time data from the provider 110. The blocked out period of time data indicates a date, start time and end time when a manicure/pedicure provider is unavailable and prevents a consumer from sending an appointment request for an appointment during that blocked out period of time. Appointment data 214 may also include data pertaining to whether the provider accepts an appointment request from an individual consumer.

The GUI of the computing device 120 may also be configured to receive reporting data 216 from provider 110, which relates to whether a consumer consumed services offered at an appointment, a consumer cancelled an appointment previously accepted by a manicure/pedicure provider before the appointment date and start time, or whether a “no show” occurred, indicating that a consumer failed to show up for an appointment previously accepted by a manicure/pedicure provider. Reporting data 216 is used to determine how payments should be made to the providers and debits charged to consumers.

The server, after receiving the data 212 is configured for generating and storing the plurality of provider records corresponding to a plurality of manicure/pedicure providers that provide offered services. Each provider record includes provider data 212 and a unique provider identifier for a manicure/pedicure provider. The data input 212 may be transmitted, over the communications network, to the server to be displayed to the plurality of consumers on remote computing devices 124.

The server 102, after receiving the consumer data 210 is further configured for initiating a predefined electronic payment from said plurality of individual consumers at predefined intervals of time, using said electronic payment information stored in the plurality of consumer records. The electronic payments may be an automatically deducted membership fee that is to be deducted from a consumer bank or charged to the credit card or debit card of the consumer. The electronic payments may also correspond to the services consumed, no shows or cancellations of individual consumers.

The server 102 is also configured for receiving a plurality of appointment requests or modifications to appointment requests 204 from said plurality of individual consumers. Each appointment request or modification includes a unique consumer identifier, a unique provider identifier, an identifier for an offered service intended to be consumed at a corresponding manicure/pedicure provider, and an appointment date and time. The server is also configured for routing each appointment request or modification of the plurality of appointment requests in a message 222 to the manicure/pedicure provider identified in each appointment request. Similarly, a message 222 may be transmitted to consumers, and said message can include messages that indicate whether a provider has accepted or denied an appointment request or appointment modification request.

The server is also configured for receiving a plurality of messages 214 from said plurality of manicure/pedicure providers. Each message 214 indicates that a provider has accepted an appointment request for a particular time slot for an offered service at a manicure/pedicure provider. Additionally, the provider may also be provided with a graphical user interface by the server to schedule appointments for customers, and to invite other customers to accept the same appointment time. Once a consumer requests an appointment, there is a button to “Share” with other subscribers who can then choose to book an appointment having the same time appointment with same provider, if they so choose.

The server is also configured for receiving a plurality of messages 216 from said plurality of manicure/pedicure providers. Each message 216 indicates that a consumer has consumed an offered service at a manicure/pedicure provider (or cancelled an appointment or simply not shown up for the appointment). Each message 216 includes a unique consumer identifier, a unique provider identifier and an identifier for the offered service that was consumed. Each message 216 may also include a cancellation identifier indicating if a consumer cancelled an appointment previously accepted by a manicure/pedicure provider before the appointment date and start time, and a no-show identifier indicating a consumer failed to show up for an appointment previously accepted by a manicure/pedicure provider.

The server is also configured for generating a human-readable spreadsheet file 224 based on said plurality of messages. The server is also configured for automatically generating a NACHA formatted file 226 based on said spreadsheet file. See above for a description of the data that may be found in a human-readable spreadsheet file and a NACHA formatted file. The server is also configured for transmitting, via the communications network, to the source bank 142 the NACHA formatted file for generating a plurality of ACH transfers to be transmitted from the source bank to the plurality of provider banks 140 at one time.

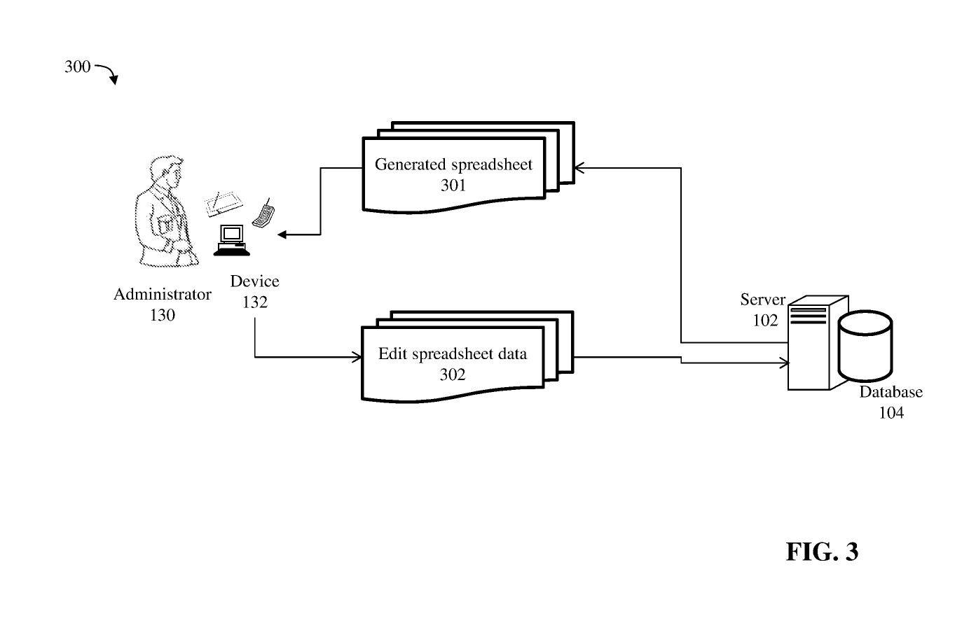

FIG. 3 is a block diagram 300 showing the data flow of the process for editing human-readable spreadsheet files over a communications network, according to one embodiment. As mentioned above, the server is configured for generating a human-readable spreadsheet file 301 based upon said plurality of messages. The server is configured for providing a user interface on remote computer 132 for system administrator to input data to edit the human-readable spreadsheet file, which can then be transmitted to the server in a message 302. The administrator may desire to edit the file to fix any mistakes or make necessary adjustments. After the file is edited, the server may then transmit a message to the display device of the graphical user interface 132 for the administrator to further edit the spreadsheet if necessary.

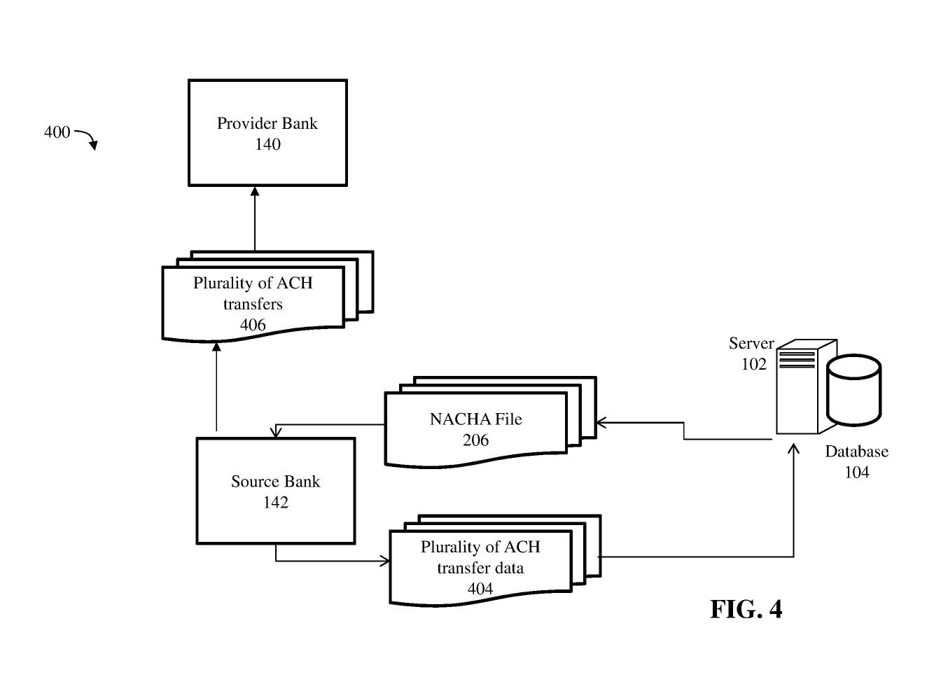

FIG. 4 is a block diagram 400 showing the data flow of the process for generating and transmitting NACHA formatted files and executing ACH transfers over a communications network, according to one embodiment. The server is configured to automatically generate a NACHA formatted file 206, based upon the automatically generated or edited human-readable spreadsheet. The server is also configured for transmitting the NACHA formatted file from the server to a source bank. The source bank 142 is configured for receiving the file 206, effecting a plurality of ACH transfers 406 to provider banks 140 according to the NACHA formatted file 206, and reporting said transactions 404 to the server 102.

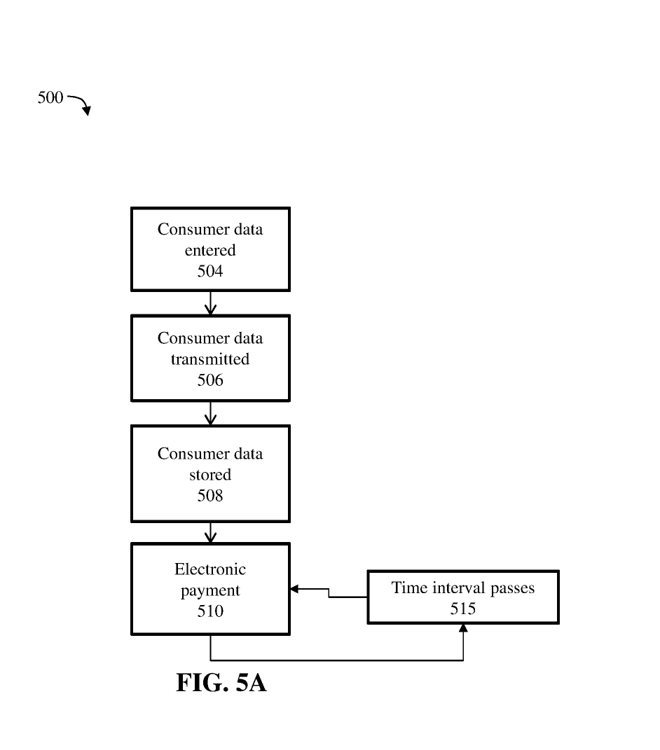

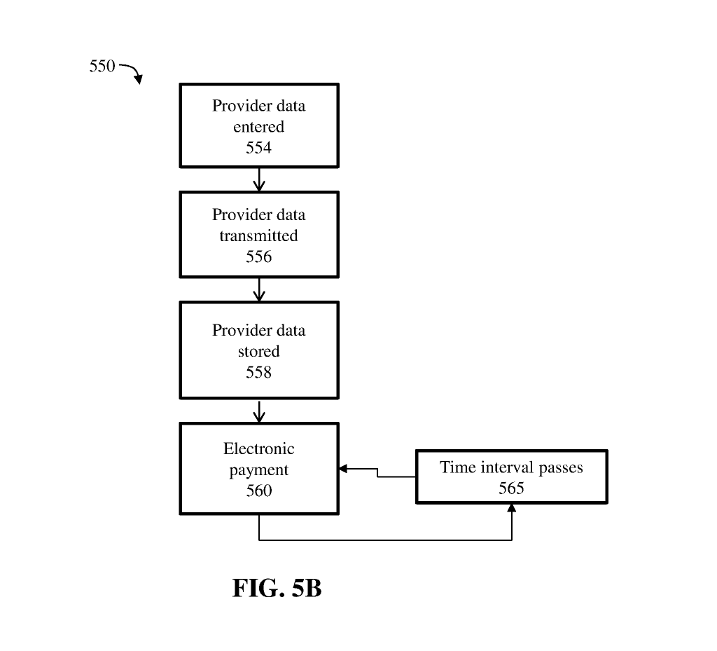

FIG. 5A is a flow chart 500 depicting the general control flow of the process for enrolling consumers and effectuating payment from same over a communications network, according to one embodiment. In step 504, the consumer enrolls or registers with the system by using the GUI provided by the server on computing device 124, to enter in the consumer data 210. When creating a consumer profile, the GUI may request information, such as name, address, age, date of birth of the consumer. If the consumer is between the ages of 14 and 17, for example, the server may provide another GUI wherein a parent or legal guardian must provide permission and contract guaranteed payment for the consumed services of a minor. If a consumer is between the ages of 14 and 17, then server 102 can provide a GUI where a parent or guardian can enter a passcode to protect editing and viewing payment information not viewable by the child user.

As mentioned above, in step 506, the consumer data is transmitted to the server, and in step 508 the consumer data 210 is stored in a consumer record. In one embodiment, in step 508 the server stores at least 100,000 consumers records (see above for an explanation of the significance of said number of consumers). In step 510, the server 102 initiates a predetermined electronic payment from each individual consumer (using the payment data entered by the consumer in his consumer record), which re-occurs at predefined intervals of time 515. The predetermined electronic payment may be a set amount that is paid each month, for example, or other period of time as a membership fee or monthly enrollment fee. In another embodiment, the periodic payment may be calculated each month, or other time interval, depending on the consumer's activity. For example, the periodic payment may reflect each of the services that the consumer consumed for the preceding period, the number of canceled appointments the consumer incurred for the preceding period and/or the number of no-show appointments the consumer incurred for the preceding period. The manner in which the periodic payment is calculated is described in greater detail below.

In an alternative embodiment, electronic payments from each individual consumer (using the payment data entered by the consumer in his consumer record) need not occur at predefined intervals of time 515, but may also be performed at any time or for one-off or single payments. An electronic payment may be effectuated, for example, the moment a user cancels an appointment or the moment a consumer is deemed a no-show for a previously scheduled appointment. Payments for a cancelled appointment or for a no-show may be for an amount previously agreed upon.

FIG. 5B is a flow chart depicting the general control flow 550 of the process for enrolling manicure/pedicure providers over a communications network, according to one embodiment. In step 554, the provider enrolls or registers with the system by using the GUI provided by the server on computing device 120, to enter in the provider data 212. When creating a provider profile, the GUI may request information, such as name, address, type of location, type of provider, list of services, etc. of the provider. As mentioned above, in step 556, the provider data is transmitted to the server, and in step 558 the provider data 212 is stored in a provider record. In one embodiment, in step 558 the server stores at least 10,000 provider records (see above for an explanation of the significance of said number of providers).

It is understood that in step 554, the provider may also include any time that the provider does not want to accept appointment requests, known as “black-out” or “block out” times that the provider will not be available for booking or other customers have already scheduled. It is also understood that in 554, provider may also include modifications to the schedule.

In step 560, the server 102 initiates an electronic payment to each individual provider (using the bank account data in its provider record), which re-occurs at predefined intervals of time 565. The predetermined electronic payment may be a set amount that is paid each month, for example, or other period of time as a provider fee or monthly enrollment fee. In another embodiment, the periodic payment may be calculated each month, or other time interval, depending on the amount activity effectuated by the provider. For example, the periodic payment may reflect each of the services that enrolled consumers consumed at the provider for the preceding period, the number of cancelled appointments that enrolled consumers incurred at the provider for the preceding period and/or the number of no-show appointments that enrolled consumers incurred at the provider for the preceding period. The manner in which the periodic payment is calculated is described in greater detail below.

In an alternative embodiment, electronic payments to each individual provider (using the bank account data in its provider record) need not occur at predefined intervals of time 565, but may also be performed at any time or for one-off or single payments. An electronic payment may be effectuated, for example, the moment a user cancels an appointment or the moment a consumer is deemed a no-show for a previously scheduled appointment. Payments for a cancelled appointment or for a no-show may be for an amount previously agreed upon.

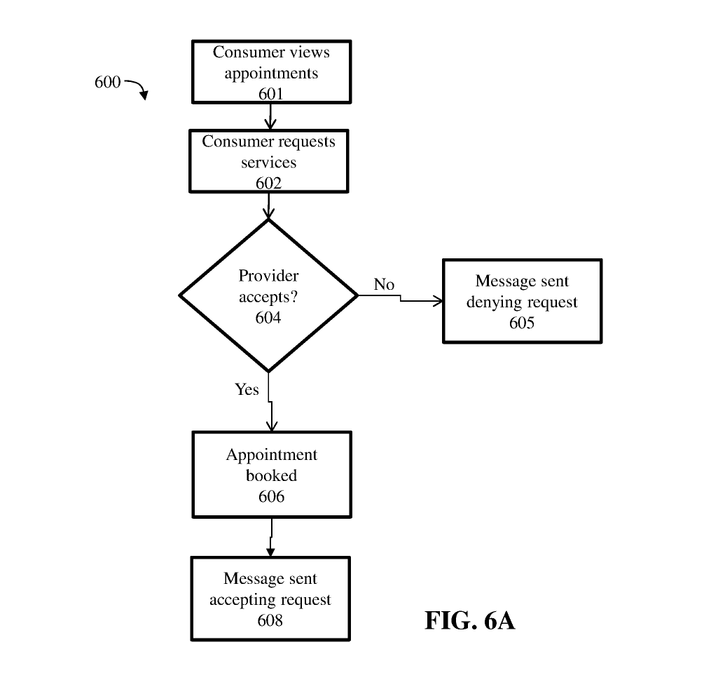

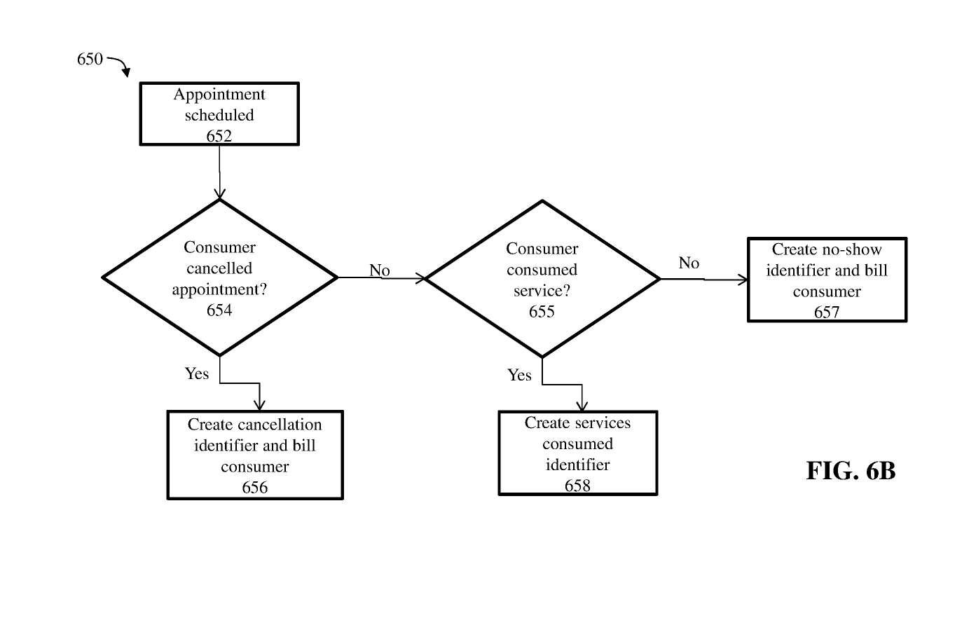

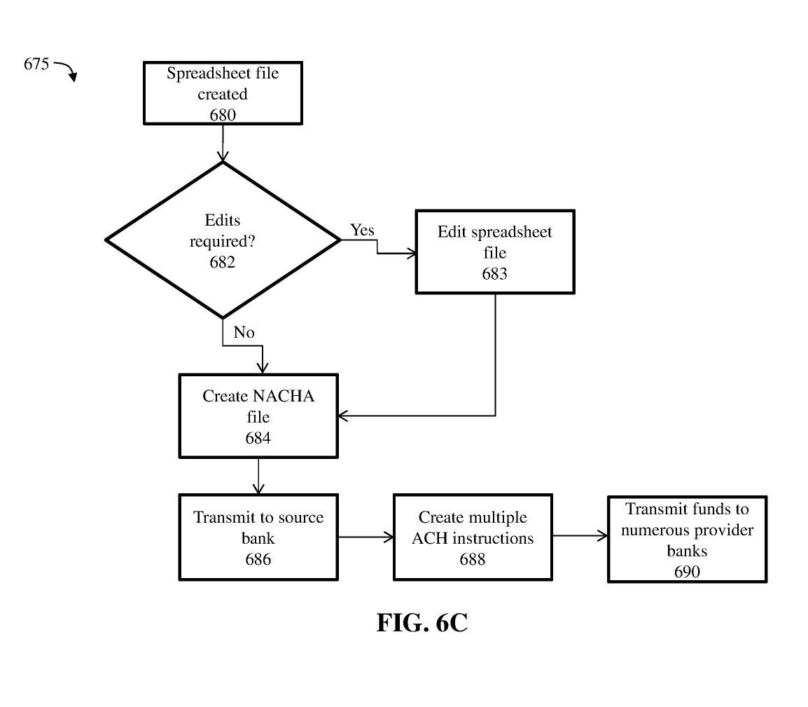

FIG. 6A is a flow chart depicting the general control flow 600 of the process for booking appointments for offered services, according to one embodiment. In step 601, the consumer logs onto the system and views the available appointments dates, times and offered services using the GUI provided by server on device 124. These available appointments are those based upon data 204, 214 received and stored by the server. The consumer can search for filter the appointments based upon offered service, appointment time, geographic location, date, price, etc. Next, in step 602 the consumer inputs an appointment request 204 for an offered service and the server routes the appointment requests to the manicure/pedicure provider in message 222 identified in the appointment request. Next, in optional step 604, the provider can accept or deny each appointment request of each individual consumer by inputting data into a GUI provided by server and such denial/acceptance message 214 will be transmitted to the server.

If the provider does not accept appointment request within a predetermined time or the provider denies the appointment request from the consumer, then the process moves to optional step 605 and a message 222 is transmitted to a GUI provided by the server on device 124 denying the request for services. Note that steps 604 and 605 are optional because in one embodiment, there is no acceptance needed from the provider—once the customer books the appointment, it is scheduled. If the provider accepts the appointment requests, then in step 606 the appointment is booked. In one embodiment, in step 608, a message 222 is transmitted to a GUI provided by the server on device 124 to the customer 112 notifying that the provider has accepted the appointment request.

FIG. 6B is a flow chart depicting the general control flow 650 of the process for reporting on consumer activity, according to one embodiment. FIG. 6B describes the process used by server 102 to received reporting data 216 and use said data to determine how payments should be made to the providers and debits charged to consumers. In step 652, an appointment that has been requested by a consumer and accepted by a provider has been scheduled. Then in step 654, server will may provide a GUI for allowing the provider to input information related to whether a consumer has cancelled a previously scheduled appointment. If the consumer has cancelled a previously scheduled appointment, then the process moves to step 656 and the message that will be transmitted to the server would indicate that a consumer has cancelled a previously scheduled appointment. This information may include a payment identifier that indicates a consumer has cancelled a previously scheduled appointment. Said message may also include a unique customer identifier, a unique provider identifier, a unique appointment identifier, etc.

Note that in an alternative embodiment, electronic payments by the consumer need not occur at predefined intervals of time, but may also be performed at any time or for one-off or single payments. An electronic payment may be effectuated, for example, the moment a user cancels an appointment (as in step 656 above). Payments for a cancelled appointment may be for an amount previously agreed upon.

If the consumer has not cancelled a previously scheduled appointment, then the process moves to step 655. In step 655, if the appointment was canceled, then a provider will input information into the GUI provided by the server on device 120 indicating that the consumer has consumed offered services at the provider. If the consumer has consumed offered services at the provider, then the process moves to step 658 and the message that will be transmitted to the server would indicate that the consumer has consumed offered services at the provider. This information may include a payment identifier that indicates a consumer has consumed offered services at the provider. Said message may also include a unique customer identifier, a unique provider identifier, a unique appointment identifier, etc.

If the appointment request was not canceled and the offered services were not consumed or used by the consumer, then the process would move to step 657, which indicates a no-show. If the appointment was a no-show, then the message that will be transmitted to the server would indicate that the appointment was a no-show. This information may include a payment identifier that defines whether an appointment was a no-show. Said message may also include a unique customer identifier, a unique provider identifier, a unique appointment identifier, etc.

Note that in the alternative embodiment, electronic payments by the consumer need not occur at predefined intervals of time, but may also be performed at any time or for one-off or single payments. An electronic payment may be effectuated, for example, the moment a user is a no-show for an appointment (as in step 657 above). Payments for a no-show may be for an amount previously agreed upon.

FIG. 6C is a flow chart depicting the general control flow 675 of the process for making monetary transfers to manicure/pedicure providers, according to one embodiment. In step 680, a human readable spreadsheet file is automatically generated by the server based on the plurality of messages from the customers and providers. In other embodiments, the human-readable spreadsheets may not be automatically generated and may require a command issued from the system administrator. In step 682, the system administrator, using the GUI provided by the server over the communications network to computing device 132, will review the human-readable spreadsheet to determine if any edits to the human-readable spreadsheet are required. If edits are required, then in step 683 the system administrator using the GUI will input data to edit the spreadsheet. Next, the process will move to step 684. It is understood that step 682 may be skipped or relocated such that a NACHA formatted file is also automatically generated by the server with the human-readable spreadsheet. In step 684, a NACHA formatted file is automatically generated by the server and corresponds to the human-readable spreadsheet. Next, in step 686, the NACHA formatted file will be transmitted by the server over the communications network to a source bank. The source bank 142 may be a single bank or other payment processing facility or a plurality of banks or payment processing facilities. Next, in step 688, multiple ACH transfer instructions are created by the source bank based on the NACHA formatted file. Next, in step 690, funds are transmitted by the course bank to numerous provider banks at one time based upon the NACHA formatted file that corresponds to the human-readable file.

As explained above, in step 560, the server calculates the amount of a monetary transfer to a provider, based on the activity that occurred at the provider during the preceding time interval. In one embodiment, the amount of a monetary transfer to a manicure/pedicure service provider for one business days' worth of services is calculated according to the following formula:

Amount=a′·a+b′·b+c′·c

wherein

a′ represents the number of manicures/pedicures (or other offered service) provided by the service provider to enrolled consumers on said business day,

a represents the amount paid to the service provider for one manicure/pedicure (or other offered service),

b′ represents the number of cancellations of manicures/pedicures (or other offered service) by enrolled consumers that occurred on said business day,

b represents the amount paid to the service provider for one cancellation,

c′ represents the number of no-shows for booked appointments that occurred on said business day, and

c represents the amount paid to the service provider for one no-show for a booked appointment.

In one embodiment, it may be desired to pay manicure/pedicure service providers not just for one business day, but for an n-day period comprising “n” business days. This will result in fewer monetary transfers to the service providers throughout a business year, but each monetary transfer will be for a larger amount of money. In this embodiment, the amount of a monetary transfer to a manicure/pedicure service provider for “n” business days' worth of services is calculated according to the following formula:

$$Amount = {\sum }_{i = 1}^{n} {a}_{i}^{′} \cdot a + {b}_{i}^{′} \cdot b + {c}_{i}^{′} \cdot c$$

wherein

aᵢ′ represents the number of manicures/pedicures provided by the service provider to enrolled consumers on business day i of the n-day period,

a represents the amount paid to the service provider for one manicure/pedicure,

bᵢ′ represents the number of cancellations of manicures/pedicures by enrolled consumers that occurred on business day i of the n-day period,

b represents the amount paid to the service provider for one cancellation,

cᵢ′ represents the number of no-shows for booked appointments that occurred on business day i of the n-day period, and

c represents the amount paid to the service provider for one no-show for a booked appointment.

As explained above, in step 510, the server calculates the amount of a debit charged to a consumer, based on the consumer's activity that occurred during the preceding time interval. In one embodiment, the amount of a debit charged to a consumer for one business days' worth of services is calculated according to the following formula:

Amount=a′·a+b′·b+c′·c

wherein

a′ represents the number of manicures/pedicures (or other offered service) consumed by the consumer on said business day,

a represents the amount charged to the consumer for one manicure/pedicure (or other offered service),

b′ represents the number of cancellations of manicures/pedicures (or other offered service) by the consumer that occurred on said business day,

b represents the amount charged to the consumer for one cancellation,

c′ represents the number of no-shows for booked appointments that the consumer effectuated on said business day, and

c represents the amount charged to the consumer for one no-show for a booked appointment.

In one embodiment, it may be desired to debit consumers not just for one business day, but for an n-day period comprising “n” business days. This will result in fewer debits to the consumer throughout a business year, but each monetary transfer will be for a larger amount of money. In this embodiment, the amount of a monetary debit to a consumer for “n” business days' worth of services is calculated according to the following formula:

$$Amount = {\sum }_{i = 1}^{n} {a}_{i}^{′} \cdot a + {b}_{i}^{′} \cdot b + {c}_{i}^{′} \cdot c$$

wherein

aᵢ′ represents the number of manicures/pedicures consumed by the consumer on business day i of the n-day period,

a represents the amount charged to the consumer for one manicure/pedicure,

bᵢ′ represents the number of cancellations of manicures/pedicures by the consumer that occurred on business day i of the n-day period,

b represents the amount charged to the consumer for one cancellation,

cᵢ′ represents the number of no-shows for booked appointments effectuated by the consumer that occurred on business day i of the n-day period, and

c represents the amount charged to the consumer for one no-show for a booked appointment.

In one alternative embodiment, the amount of a monetary transfer to a manicure/pedicure service provider for one business days' worth of services is calculated according to the following formula:

Amount=a₁′·a₁+a₂′·a₂+b′·b+c′·c+d′·d

wherein

a₁′ represents the number of lower quality or less expensive manicures/pedicures (or other offered service) provided by the service provider to enrolled consumers on said business day,

a₁ represents the amount paid to the service provider for one lower quality or less expensive manicure/pedicure (or other offered service),

a₂′ represents the number of higher quality or more expensive manicures/pedicures (or other offered service) provided by the service provider to enrolled consumers on said business day,

a₂ represents the amount paid to the service provider for one higher quality or more expensive manicure/pedicure (or other offered service),

b′ represents the number of cancellations of manicures/pedicures (or other offered service) by enrolled consumers that occurred on said business day,

b represents the amount paid to the service provider for one cancellation,

c′ represents the number of no-shows for booked appointments that occurred on said business day,

c represents the amount paid to the service provider for one no-show for a booked appointment,

d′ represents the number of additional offered services (not part of the monthly program for which consumer pays a periodic or monthly fee) provided by the service provider to enrolled consumers on said business day,

d represents the amount paid to the service provider for one additional offered service.

In another embodiment, it may be desired to pay manicure/pedicure service providers not just for one business day, but for an n-day period comprising “n” business days. This will result in fewer monetary transfers to the service providers throughout a business year, but each monetary transfer will be for a larger amount of money. In this embodiment, the amount of a monetary transfer to a manicure/pedicure service provider for “n” business days' worth of services is calculated according to the following formula:

$$Amount = {\sum }_{{c}_{i}^{′} \cdot }^{n} {a}_{1 i}^{′} \cdot {a}_{1} + {a}_{2 i}^{′} \cdot {a}_{2} + {b}_{i}^{′} \cdot b + {c}_{i}^{′} \cdot c + {d}_{i}^{′} \cdot d$$

wherein

a₁ᵢ′ represents the number of lower quality or less expensive manicures/pedicures provided by the service provider to enrolled consumers on business day i of the n-day period, etc.

As explained above, in step 510, the server calculates the amount of a debit charged to a consumer, based on the consumer's activity that occurred during the preceding time interval. In one embodiment, the amount of a debit charged to a consumer for one business days' worth of services is calculated according to the following formula:

Amount=a₁′·a₁+a₂′·a₂+b′·b+c′·c+d′·d

In one embodiment, it may be desired to debit consumers not just for one business day, but for an n-day period comprising “n” business days. This will result in fewer debits to the consumer throughout a business year, but each monetary transfer will be for a larger amount of money. In this embodiment, the amount of a monetary debit to a consumer for “n” business days' worth of services is calculated according to the following formula:

$$Amount = {\sum }_{i = 1}^{n} {a}_{1 i}^{′} \cdot {a}_{1} + {a}_{2 i}^{′} \cdot {a}_{2} + {b}_{i}^{′} \cdot b + {c}_{i}^{′} \cdot c + {d}_{i}^{′} \cdot d$$

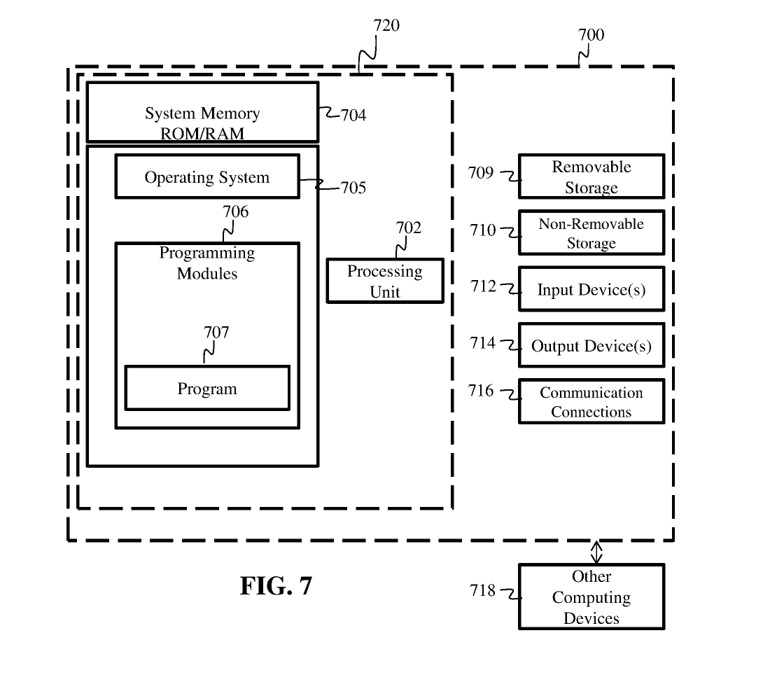

FIG. 7 is a block diagram of a system including an example computing device 700 and other computing devices. Consistent with the embodiments described herein, the aforementioned actions performed by 102, 120, 124, and 132 may be implemented in a computing device, such as the computing device 700 of FIG. 7. Any suitable combination of hardware, software, or firmware may be used to implement the computing device 700. The aforementioned system, device, and processors are examples and other systems, devices, and processors may comprise the aforementioned computing device. Furthermore, computing device 700 may comprise an operating environment for the methods and data flow shown in FIGS. 2-6C above.

With reference to FIG. 7, a system consistent with an embodiment may include a plurality of computing devices, such as computing device 700. In a basic configuration, computing device 700 may include at least one processing unit 702 and a system memory 704. Depending on the configuration and type of computing device, system memory 704 may comprise, but is not limited to, volatile (e.g. random access memory (RAM)), non-volatile (e.g. read-only memory (ROM)), flash memory, or any combination or memory. System memory 704 may include operating system 705, one or more programming modules 706 (such as program module 707). Operating system 705, for example, may be suitable for controlling computing device 700's operation. In one embodiment, programming modules 706 may include, for example, a program module 707. Furthermore, embodiments may be practiced in conjunction with a graphics library, other operating systems, or any other application program and is not limited to any particular application or system. This basic configuration is illustrated in FIG. 7 by those components within a dashed line 720.

Computing device 700 may have additional features or functionality. For example, computing device 700 may also include additional data storage devices (removable and/or non-removable) such as, for example, magnetic disks, optical disks, or tape. Such additional storage is illustrated in FIG. 7 by a removable storage 709 and a non-removable storage 710. Computer storage media may include volatile and nonvolatile, removable and non-removable media implemented in any method or technology for storage of information, such as computer readable instructions, data structures, program modules, or other data. System memory 704, removable storage 709, and non-removable storage 710 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 700. Any such computer storage media may be part of device 700. Computing device 700 may also have input device(s) 712 such as a keyboard, a mouse, a pen, a sound input device, a camera, a touch input device, etc. Output device(s) 714 such as a display, speakers, a printer, etc. may also be included. The aforementioned devices are only examples, and other devices may be added or substituted.

Computing device 700 may also contain a communication connection 716 that may allow device 700 to communicate with other computing devices 718, such as over a network in a distributed computing environment, for example, an intranet or the Internet. Communication connection 716 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 704, including operating system 705. While executing on processing unit 702, programming modules 706 may perform processes including, for example, one or more of the methods shown in FIGS. 2-6C above. The aforementioned processes are examples, and processing unit 702 may perform other processes. Other programming modules that may be used in accordance with embodiments may include electronic mail and contacts applications, word processing applications, spreadsheet applications, database applications, slide presentation applications, drawing or computer-aided application programs, etc.

Generally, consistent with embodiments, program modules may include routines, programs, components, data structures, and other types of structures that may perform particular tasks or that may implement particular abstract data types. Moreover, embodiments may be practiced with other computer system configurations, including hand-held devices, multiprocessor systems, microprocessor-based or programmable consumer electronics, minicomputers, mainframe computers, and the like. Embodiments may also be practiced in distributed computing environments where tasks are performed by remote processing devices that are linked through a communications network. In a distributed computing environment, program modules may be located in both local and remote memory storage devices.

Furthermore, embodiments may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments may also be practiced using other technologies capable of performing logical operations such as, for example, AND, OR, and NOT, including but not limited to mechanical, optical, fluidic, and quantum technologies. In addition, embodiments may be practiced within a general purpose computer or in any other circuits or systems.

Embodiments, for example, are described above with reference to block diagrams and/or operational illustrations of methods, systems, and computer program products according to said embodiments. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments have been described, other embodiments may exist. Furthermore, although embodiments have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the claimed subject matter.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer system for scheduling manicure and/or pedicure appointments and managing payments for same over a communications network, comprising:
a database for storing a plurality of consumer records corresponding to a plurality of individual consumers, wherein each consumer record includes said a unique consumer identifier for an individual consumer, and consumer data comprising electronic payment information, and for storing a plurality of provider records corresponding to a plurality of manicure and/or pedicure providers that provide offered services, wherein each provider record includes provider data, provider bank account data and a unique provider identifier for a manicure and/or pedicure provider;
a memory;
a network interface device communicatively coupled with the communications network; and
a processor communicatively coupled with the data, the memory and the network interface device, the processor configured for:
initiating a predefined electronic payment from said plurality of individual consumers at predefined intervals of time, using said electronic payment information stored in the plurality of consumer records;
receiving a plurality of appointment requests from said plurality of individual consumers, wherein each appointment request includes a unique consumer identifier, a unique provider identifier and a date and time for an appointment;
routing each appointment request of the plurality of appointment requests to the manicure and/or pedicure provider identified in each appointment request by said unique provider identifier;
receiving a plurality of messages from said plurality of manicure and/or pedicure providers, wherein each message indicates that payment is due to a manicure and/or pedicure provider, and wherein each message includes a unique consumer identifier, a unique provider identifier and a payment identifier;
generating a human-readable spreadsheet file based on said plurality of messages, wherein said spreadsheet file lists, for each message of the plurality of messages, the unique provider identifier corresponding to said message, a payment identifier corresponding to said message, and a predefined payment amount corresponding to said payment identifier; and
generating a NACHA-formatted file based on said spreadsheet file, wherein said NACHA-formatted file lists, for each manicure and/or pedicure provider of the plurality of manicure and/or pedicure providers, the unique provider identifier corresponding to said manicure and/or pedicure provider, the provider bank account data corresponding to said manicure and/or pedicure provider, source bank account data, and a monetary transfer amount to said manicure and/or pedicure provider for payment for an n-day period comprising n days, wherein said monetary transfer amount is calculated according to the following formula:
$${\sum }_{i = 1}^{n} {a}_{i}^{′} \cdot a + {b}_{i}^{′} \cdot b +$$
wherein
aᵢ′ represents a number of manicures/pedicures provided by said manicure and/or pedicure provider on day i of the n-day period,
a represents a predefined payment amount corresponding to one manicure and/or pedicure,
bᵢ′ represents a number of cancellations of an appointment request previously accepted by said manicure and/or pedicure provider, wherein said cancellations occurred on day i of the n-day period,
b represents a predefined payment amount corresponding to one cancellation,
cᵢ′ represents the number of no-shows for an appointment request previously accepted by said manicure and/or pedicure provider, wherein said no-shows occurred on day i of the n-day period, and
c represents a predefined payment amount corresponding to one no-show.

2. The computer system of claim 1, wherein the processor is further configured for:
transmitting, via the communications network, to a source bank identified by said source account data, the NACHA-formatted file for generating a plurality of ACH transfers from the source bank to provider banks corresponding to the plurality of manicure and/or pedicure providers.

3. The computer system of claim 1, wherein the processor is further configured for:
updating each of the plurality of consumer records to reflect data in the human-readable spreadsheet file.

4. A method on a server for scheduling manicure and/or pedicure appointments and managing payments for same, comprising:
receiving, via a communications network communicably coupled with the server, consumer data from a plurality of individual consumers, wherein said consumer data includes electronic payment information;
generating and storing at least 100,000 consumer records corresponding to said plurality of individual consumers, wherein each consumer record includes said consumer data and a unique consumer identifier for an individual consumer;
generating and storing at least 10,000 provider records corresponding to a plurality of manicure and/or pedicure providers that provide offered services, wherein each provider record includes provider data, provider bank account data and a unique provider identifier for a manicure and/or pedicure provider;
initiating a predefined electronic payment from said plurality of individual consumers at predefined intervals of time, using said electronic payment information stored in the consumer records;
receiving a plurality of appointment requests from said plurality of individual consumers, wherein each appointment request includes a unique consumer identifier, a unique provider identifier and a date and time for an appointment;
routing each appointment request of the plurality of appointment requests to a manicure and/or pedicure provider identified in each appointment request by said unique provider identifier;
receiving a plurality of messages from said plurality of manicure and/or pedicure providers, wherein each message indicates that a consumer has consumed an offered service at a manicure and/or pedicure provider, and wherein each message includes a unique consumer identifier and a unique provider identifier;
generating a human-readable spreadsheet file based on said plurality of messages, wherein said spreadsheet file lists, for each offered service that was consumed, the unique provider identifier corresponding to said offered service, and a predefined payment amount corresponding to said offered service;
calculating, for each manicure and/or pedicure provider of said plurality of manicure and/or pedicure providers, a monetary transfer amount by multiplying a number of instances of consumers consuming an offered service at said manicure and/or pedicure provider by the predefined payment amount corresponding to said offered service; and
generating a NACHA-formatted file based on said spreadsheet file, wherein said NACHA-formatted file lists, for each manicure and/or pedicure provider of said plurality of manicure and/or pedicure providers, the unique provider identifier, the monetary transfer amount, the provider bank account data corresponding to the unique provider identifier and source bank account data.

5. The method of claim 4, wherein the method further includes:
providing, over the communications network, a first graphical user interface, to each individual consumer of the individual consumers, the first graphical user interface configured for allowing each individual consumer to input consumer data;
providing, over the communications network, a second graphical user interface to each manicure and/or pedicure provider of the plurality of manicure and/or pedicure providers, the second graphical user interface configured for allowing each manicure and/or pedicure provider to input provider data and provider bank account data; and,
providing, over the communications network, a third graphical user interface to a system administrator, the third graphical user interface configured for allowing the system administrator to edit the human-readable spreadsheet file.

6. The method of claim 4, wherein the method further includes:
transmitting, via the communications network, to a source bank identified by said source bank account data, the NACHA-formatted file for generating a plurality of ACH transfers from the source bank to provider banks corresponding to the plurality of manicure and/or pedicure providers.

7. The method of claim 4, wherein each appointment request further includes an appointment duration.

8. The method of claim 7, further comprising:
responsive to routing each appointment request of the plurality of appointment requests to the manicure and/or pedicure provider identified in each appointment request, receiving a plurality of messages from said plurality of manicure and/or pedicure providers, wherein each of the plurality of messages indicates that a manicure and/or pedicure provider has accepted an appointment request.

9. The method of claim 4, wherein each message of the plurality of messages further comprises:
either a cancellation identifier indicating that an individual consumer cancelled an appointment request previously accepted by a manicure and/or pedicure provider, wherein the individual consumer cancelled before the appointment date and start time;
or a no-show identifier indicating that an individual consumer did not arrive at an appointment request previously accepted by a manicure and/or pedicure provider.

10. The method of claim 4, wherein each provider record further includes blocked out period of time data, wherein the blocked out period of time data indicates a date, start time and end time when a manicure and/or pedicure provider is unavailable and prevents a consumer from sending an appointment request for an appointment during said date, start time and end time, and wherein each message of the plurality of messages further includes said blocked out period of time data.

11. The method of claim 4, further comprising:
updating each of the consumer records to reflect data in the human-readable spreadsheet file.

12. A method on a server for scheduling manicure and/or pedicure appointments and managing payments for same, comprising:
receiving, via a communications network communicably coupled with the server, consumer data from a plurality of individual consumers, wherein said consumer data includes electronic payment information;
generating and storing a plurality of consumer records corresponding to said plurality of individual consumers, wherein each consumer record includes said consumer data and a unique consumer identifier for an individual consumer;
generating and storing a plurality of provider records corresponding to a plurality of manicure and/or pedicure providers that provide offered services, wherein each provider record includes provider data, provider bank account data and a unique provider identifier for a manicure and/or pedicure provider;
initiating a predefined electronic payment from said plurality of individual consumers at predefined intervals of time, using said electronic payment information stored in the plurality of consumer records;
receiving a plurality of appointment requests from said plurality of individual consumers, wherein each appointment request includes a unique consumer identifier, a unique provider identifier and a date and time for an appointment;
routing each appointment request of the plurality of appointment requests to a manicure and/or pedicure provider identified in each appointment request by said unique provider identifier;
receiving a plurality of messages from said plurality of manicure and/or pedicure providers, wherein each message indicates that payment is due to a manicure and/or pedicure provider, and wherein each message includes a unique consumer identifier, a unique provider identifier and a payment identifier;
generating a human-readable spreadsheet file based on said plurality of messages, wherein said spreadsheet file lists, for each message of the plurality of messages, the unique provider identifier corresponding to said message, the payment identifier corresponding to said message, and a predefined payment amount corresponding to said payment identifier;
calculating, for each manicure and/or pedicure provider of said plurality of manicure and/or pedicure providers, a monetary transfer amount based on said plurality of messages; and
generating a NACHA-formatted file based on said spreadsheet file, wherein said NACHA-formatted file lists, for each manicure and/or pedicure provider of said plurality of manicure and/or pedicure providers, the unique provider identifier, the monetary transfer amount, the provider bank account data corresponding to the unique provider identifier and source bank account data.

13. The method of claim 12, wherein the method further includes:
providing, over the communications network, a first graphical user interface, to each individual consumer of the plurality of individual consumers, the first graphical user interface configured for allowing each individual consumer to input consumer data;
providing, over the communications network, a second graphical user interface, to each manicure and/or pedicure provider of the plurality of manicure and/or pedicure providers, the second graphical user interface configured for allowing each manicure and/or pedicure provider to input provider data and provider bank account data; and,
providing, over the communications network, a third graphical user interface to a system administrator, the third graphical user interface configured for allowing the system administrator to edit the human-readable spreadsheet file.

14. The method of claim 12, wherein the method further includes:
transmitting, via the communications network, to a source bank identified by said source bank account data, the NACHA-formatted file for generating a plurality of ACH transfers from the source bank to provider banks corresponding to the plurality of manicure and/or pedicure providers.

15. The method of claim 12, wherein each appointment request further includes an appointment duration.

16. The method of claim 15, further comprising:
responsive to routing each appointment request of the plurality of appointment requests to the manicure and/or pedicure provider identified in each appointment request, receiving a plurality of messages from said plurality of manicure and/or pedicure providers, wherein each of the plurality of messages indicates that a manicure and/or pedicure provider has accepted an appointment request.

17. The method of claim 12, wherein each provider record of the plurality of provider records further includes blocked out period of time data, wherein the blocked out period of time data indicates a date, start time and end time when a manicure and/or pedicure provider is unavailable and prevents a consumer from sending an appointment request for an appointment during said date, start time and end time, and wherein each message of the plurality of messages further includes said blocked out period of time data.

18. The method of claim 12, further comprising:
updating each of the plurality of consumer records to reflect data in the human-readable spreadsheet file.
